(19) United States
(12) Patent Application Publication
(10) Pub. No.: US 2018/0067906 A1
(43) Pub. Date: Mar. 8, 2018

(54) APPARATUS AND METHOD TO FACILITATE OPERATION OF GENERATING AND LINKING CONTENT DATA

(71) Applicant: FUJITSU LIMITED, Kawasaki-shi (JP)

(72) Inventors: Naoya FUJISAKI, Yokohama (JP); Junichi YURA, Kawasaki (JP); Akira SHIBA, Kawasaki (JP)

(73) Assignee: FUJITSU LIMITED, Kawasaki-shi (JP)

(21) Appl. No.: 15/694,077

(22) Filed: Sep. 1, 2017

(30) Foreign Application Priority Data
Sep. 7, 2016 (JP) 2016-174451

(51) Int. Cl. G06F 17/22; G06F 17/24

(52) U.S. Cl. CPC G06F 17/2235; G06F 17/24

(57) ABSTRACT

An apparatus provides a first program to generate a first content with link data to be set in the first content so as to refer to a second content. The apparatus invokes a second program when a first condition associated with the provided link data is satisfied, and stores the second content generated by the invoked second program into a storage location indicated by the provided link data.

### CROSS-REFERENCE TO RELATED APPLICATION

This application is based upon and claims the benefit of priority of the prior Japanese Patent Application No. 2016-174451, filed on Sep. 7, 2016, the entire contents of which are incorporated herein by reference.

### FIELD

The embodiments discussed herein are related to apparatus and method to facilitate operation of generating and linking content data.

### BACKGROUND

In creation of a document including photographic images on a document creation application, a method of integrating photographic image data into document data or a method of referring to the photographic images through links may be employed.

In the method of making the reference through the links, link data indicating storage locations of the photographic image data is inserted into a text. Usually, a user performs insertion work of the link data after preparing the photographic image data photographed by a camera application.

Therefore, for example, in order to create a document including a large number of photographic images, a lot of work for finishing the document after the photographing is to be performed.

The related techniques are disclosed in, for example, Japanese National Publication of International Patent Application No. 2014-532951, and Japanese Laid-open Patent Publication Nos. 2001-076006 and 2001-034612.

### SUMMARY

According to an aspect of the invention, an apparatus provides a first program to generate a first content with link data to be set in the first content so as to refer to a second content. The apparatus invokes a second program when a first condition associated with the provided link data is satisfied, and stores the second content generated by the invoked second program into a storage location indicated by the provided link data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of screen transition in a preparation phase, according to an embodiment;

FIG. 2 is a diagram illustrating an example of an operation of a user terminal in a link phase, according to an embodiment;

FIG. 3 is a diagram illustrating an example of a hardware configuration of a user terminal, according to an embodiment;

FIG. 4 is a diagram illustrating an example of a module configuration of a user terminal, according to an embodiment;

FIG. 5 is a diagram illustrating an example of a module configuration of a mediating unit, according to an embodiment;

FIG. 6 is a diagram illustrating an example of an operational sequence in a preparation phase, according to an embodiment;

FIG. 7 is a diagram illustrating an example of an operational sequence in a preparation phase, according to an embodiment;

FIG. 8 is a diagram illustrating an example of an event table, according to an embodiment;

FIG. 9 is a diagram illustrating an example of an operational sequence in a preparation phase, according to an embodiment;

FIG. 10 is a diagram illustrating an example of a cooperation table, according to an embodiment;

FIG. 11A is a diagram illustrating an example of an operational sequence in a link phase, according to an embodiment;

FIG. 11B is a diagram illustrating an example of an operational sequence in a link phase, according to an embodiment;

FIG. 12 is a diagram illustrating an example of an operational sequence in a preparation phase, according to an embodiment;

FIG. 13 is a diagram illustrating an example of an operational sequence in a preparation phase, according to an embodiment;

FIG. 14 is a diagram illustrating an example of a cooperation table, according to an embodiment;

FIG. 15 is a diagram illustrating an example of an operational sequence in a link phase, according to an embodiment;

FIG. 16 is a diagram illustrating an example of an operational sequence in a preparation phase, according to an embodiment;

FIG. 17 is a diagram illustrating an example of a policy table, according to an embodiment;

FIG. 18 is a diagram illustrating an example of an operational sequence in a preparation phase, according to an embodiment;

FIG. 19 is a diagram illustrating an example of a cooperation table, according to an embodiment;

FIG. 20 is a diagram illustrating an example of an instruction processing flow, according to an embodiment;

FIG. 21 is a diagram illustrating an example of a first policy processing flow, according to an embodiment;

FIG. 22 is a diagram illustrating an example of a second policy processing flow, according to an embodiment;

FIG. 23 is a diagram illustrating an example of a third policy processing flow, according to an embodiment; and

FIG. 24 is a diagram illustrating an example of an operational sequence in a preparation phase, according to an embodiment.

### DESCRIPTION OF EMBODIMENTS

### First Embodiment

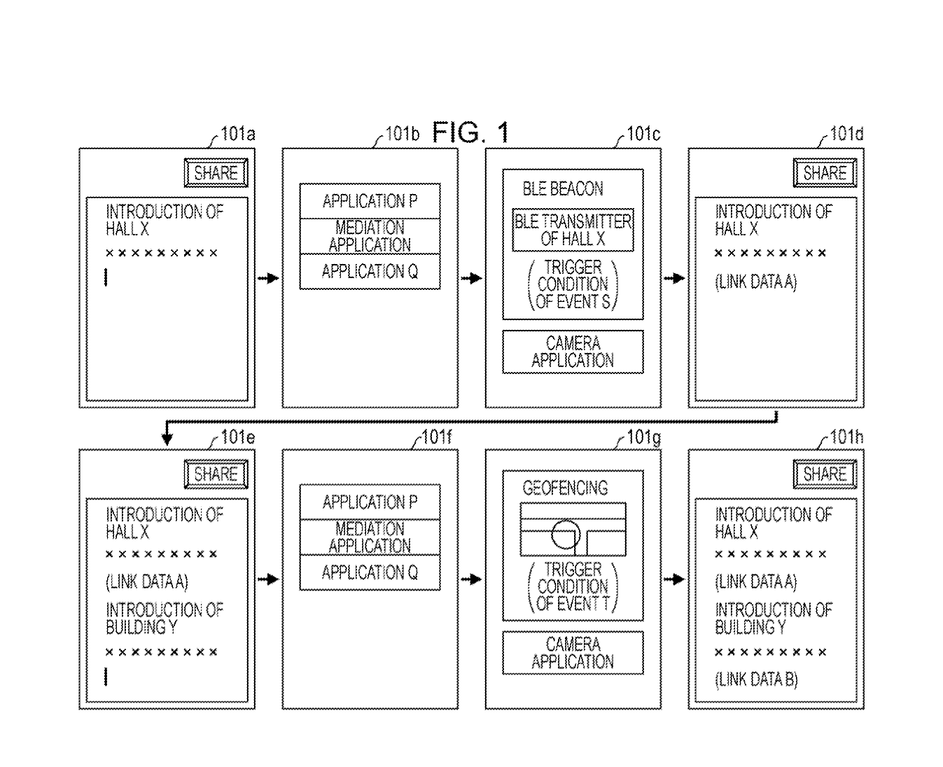

A preparation phase for linking a second content in a first content is explained. In this example, the first content is a document and the second content is a photographic image. FIG. 1 illustrates an example of screen transition in the preparation phase. The description herein is provided for a case of creating a document for introducing a hall X and a building Y by using sentences and photographs.

A screen 101a of a user terminal is displaying an editing window by a document creation application. First, a user inputs a sentence for introducing the hall X. Subsequently, the user moves a cursor to a position where a photograph of the hall X is pasted.

At this point, when the user touches a share button, a list indicating candidates for applications to be invoked by the document creation application is displayed on a screen 101b of the user terminal. In this example, an “application P”, a “mediation application”, and an “application Q” are displayed as the candidates. The mediation application is an application for mediating cooperation among applications. At this stage, the user selects the mediation application. As a result, the mediation application is executed.

A screen 101c of the user terminal displays an event setting window output by the mediation application. On the event setting window, a trigger condition of an event and an application activated at a point in time of triggering of the event are set. In this example, it is assumed that a photograph of the hall X is taken when a beacon signal transmitted from a Bluetooth (registered trademark) low energy (BLE) transmitter set in the hall X is detected. Therefore, the user selects a “BLE beacon” as a type of the event and inputs “a BLE transmitter of the hall X: HOLE-X” as a specific transmitter. BLE advertisement information transmitted by the transmitter is obtained from, for example, the Internet. A camera application is selected as the application to be activated in the hall X.

When the event setting window is closed, an editing window is displayed on a screen 101d of the user terminal. At this point, link data A for referring to a photographic image of the hall X is set in the position where the cursor was present. The link data is, for example, a URL (Uniform Resource Locator) for hyperlink.

Subsequently, as illustrated in a screen 101e of the user terminal, the user inputs a sentence for introducing the building Y and moves the cursor to a position where a photograph of the building Y is pasted.

Similarly, when the user touches the share button, a list same as the list displayed on a screen 101b is displayed on a screen 101f of the user terminal. At this point, the user also selects the mediation application.

The event setting window is displayed on the screen 101g of the user terminal in the same manner as explained above. It is assumed that approach to the building is detected by a geofence and a photograph of the building Y is taken. Therefore, the user selects a “geofence” as a type of an event and sets a range of the geofence on a map. The camera application is selected again as an application to be activated near the building Y.

When the event setting window is closed, an editing window is displayed on a screen 101h of the user terminal. At this point, link data B for referring to a photographic image of the building Y is set in the position where the cursor was present. After the document is saved, the document creation application ends. The preparation phase is as explained above.

A phase for linking the second content to the first content (hereinafter referred to as link phase) is explained. In this example, photographing by the camera application is performed and photographic image data is linked to document data.

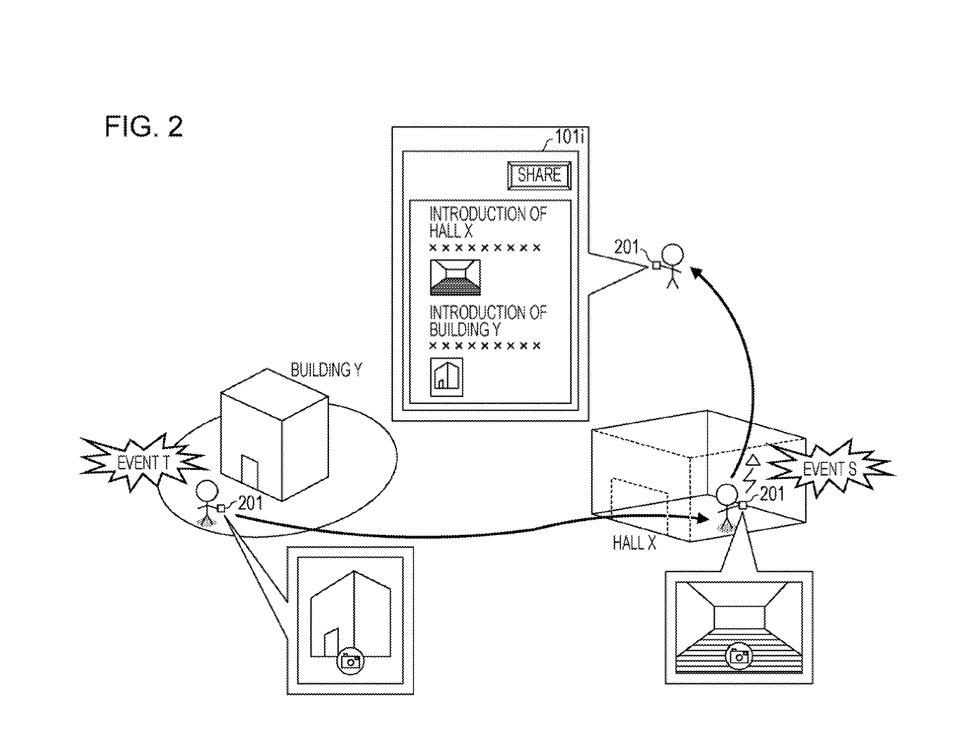

An operation example of a user terminal 201 in the link phase is illustrated in FIG. 2. In this example, it is assumed that the user visits the building Y first and thereafter drops in the hall X.

When the user approaches the building Y and the user terminal 201 enters a set range, an event T is triggered. When the event T is triggered, the camera application is automatically activated. The user photographs the building Y using the camera application. At this point, data of a photographed photographic image is stored in a storage location indicated by link data B. The user ends the camera application.

Subsequently, when the user enters a building of the hall X, the user terminal 201 receives a beacon signal transmitted from the BLE transmitter of the hall X and detects that the user approaches the BLE transmitter. As a result, an event S is triggered and the camera application is automatically activated. The user photographs the hall X by using the camera application. At this point, data of a photographed photographic image is stored in a storage location indicated by the link data A. The user ends the camera application.

In this way, the photographic image data photographed by the camera application activated near an object is immediately linked to the document data. Therefore, for example, after the photographing in the hall X, if the document creation application is activated, a document including photographic images is displayed on a screen 101i of the user terminal 201. An overview in this embodiment is as explained above.

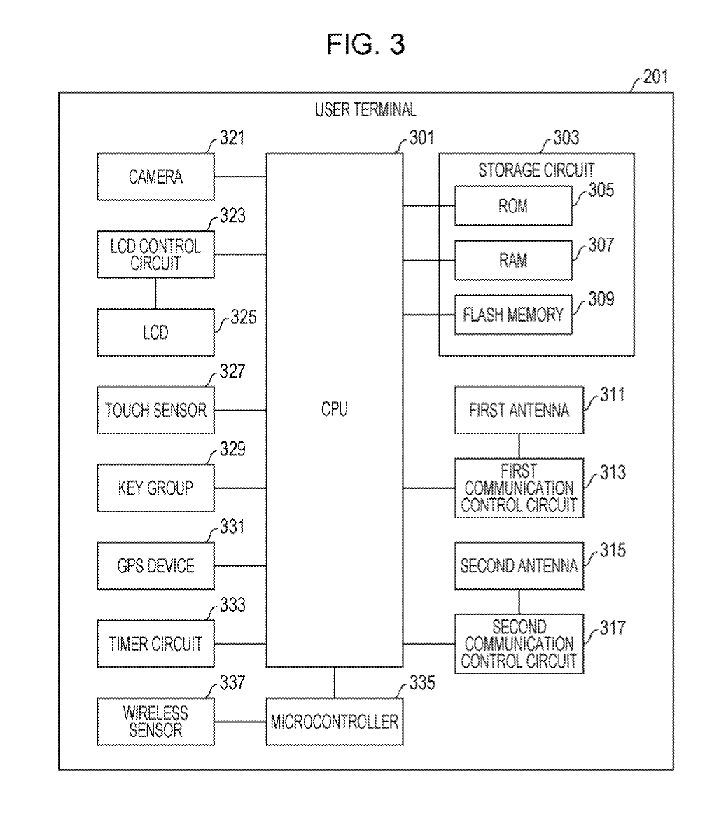

The operation of the user terminal 201 is explained below. A hardware configuration example of the user terminal 201 is illustrated in FIG. 3. The user terminal 201 includes a central processing unit (CPU) 301, a storage circuit 303, a first antenna 311, a first communication control circuit 313, a second antenna 315, a second communication control circuit 317, a camera 321, a liquid crystal display (LCD) control circuit 323, an LCD 325, a touch sensor 327, a key group 329, a global positioning system (GPS) device 331, a timer circuit 333, a microcontroller 335, and a wireless sensor 337.

The CPU 301 executes a computer program stored in the storage circuit 303. The storage circuit 303 includes, for example, a read only memory (ROM) 305, a random access memory (RAM) 307, and a flash memory 309. The ROM 305 stores therein, for example, basic computer programs and initial data. The RAM 307 includes a region where computer programs are expanded. The RAM 307 also includes a region where temporary data is stored. The flash memory 309 stores therein, for example, computer programs such as applications and user data.

The camera 321 is used for photographing of a still image or a moving image. The LCD control circuit 323 operates a clock circuit at a predetermined operating frequency and drives the LCD 325. The LCD 325 displays various screens. The touch sensor 327 is, for example, a panel-like sensor disposed on a display surface of the LCD 325. The touch sensor 327 receives an instruction by the touch operation. Specifically, the touch sensor 327 is used as a touch panel obtained by integrating the LCD 325 and the touch sensor 327. Hard keys of the key group 329 are provided in a part of a housing.

The first antenna 311 receives a radio wave by a wireless local area network (LAN) scheme. The first communication control circuit 313 performs control of wireless communication according to a frequency in use in the wireless LAN scheme. The second antenna 315 receives a radio wave by a wireless communication scheme (for example, BLE). The second communication control circuit 317 performs control of wireless communication according to a frequency in use in the wireless communication scheme. The wireless communication scheme is a communication scheme related to short range wireless communication. The second antenna 315 and the second communication control circuit 317 receive a beacon signal by the wireless communication scheme.

The microcontroller 335 is coupled to the CPU 301. A sensor is coupled to the microcontroller 335. The microcontroller 335 controls the sensor. The CPU 301 acquires a measurement result of the sensor via the microcontroller 335. In this example, the wireless sensor 337 is coupled to the microcontroller 335. The wireless sensor 337 includes an antenna that receives the radio wave by the wireless communication scheme and a circuit that controls communication by the wireless communication scheme. The wireless sensor 337 receives a beacon signal by the wireless communication scheme.

The user terminal 201 is, for example, a smartphone. However, the user terminal 201 may be a cellular phone device other than the smartphone. The user terminal 201 may be a portable electronic device other than the cellular phone device. This embodiment may be applied in a portable electronic device such as a wearable terminal of a wristwatch type, an eyeglass type, or the like, a tablet terminal, a game machine, a pedometer, a recorder, a music player, a camera, an image player, a television broadcast receiver, a radio broadcast receiver, a controller, an electronic clock, an electronic dictionary, an electronic translation machine, a radio, a GPS transmitter, a measuring device, a health support device, or a medical device. The user terminal 201 may be a stationary or portable computer.

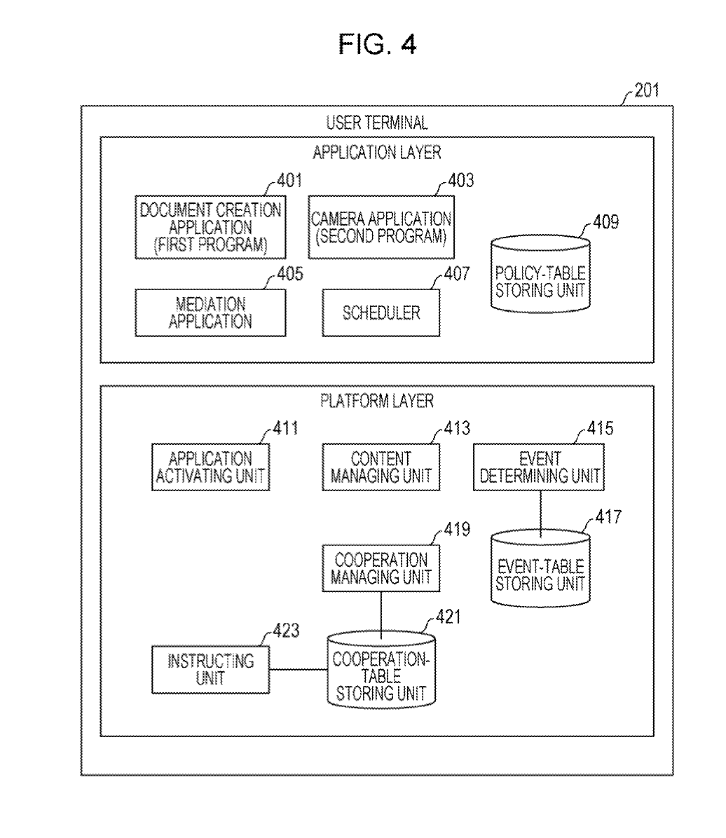

A module configuration example of the user terminal 201 is illustrated in FIG. 4. An application layer of the user terminal 201 includes a document creation application 401, a camera application 403, a mediation application 405, a scheduler 407, and a policy-table storing unit 409.

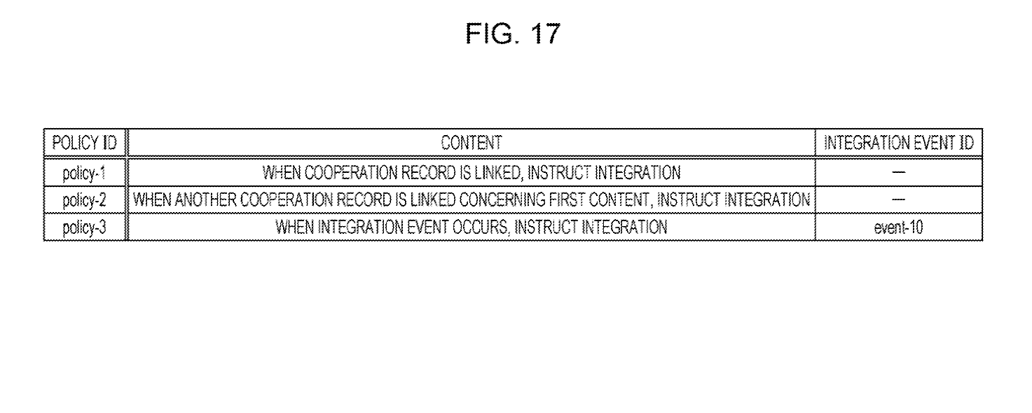

The document creation application 401 creates a document. The camera application 403 performs photographing using the camera 321. The mediation application 405 mediates cooperation among the applications. The scheduler 407 manages a schedule including a context. The scheduler 407 may be a client that uses a WEB server. The policy-table storing unit 409 stores a policy table. The policy table is explained below with reference to FIG. 17.

A platform layer of the user terminal 201 includes an application activating unit 411, a content managing unit 413, an event determining unit 415, an event-table storing unit 417, a cooperation managing unit 419, a cooperation-table storing unit 421, and an instructing unit 423.

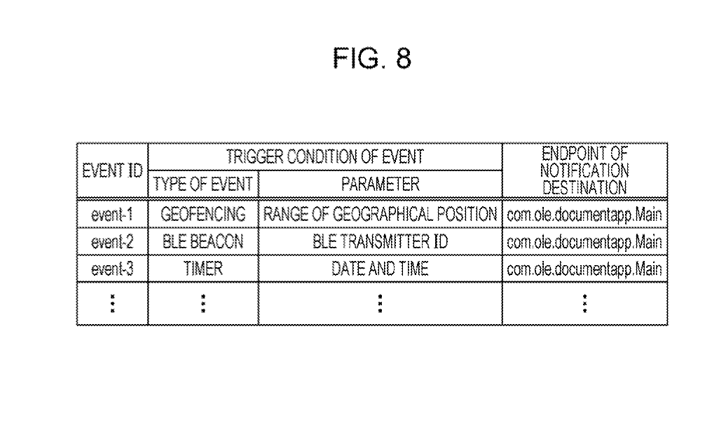

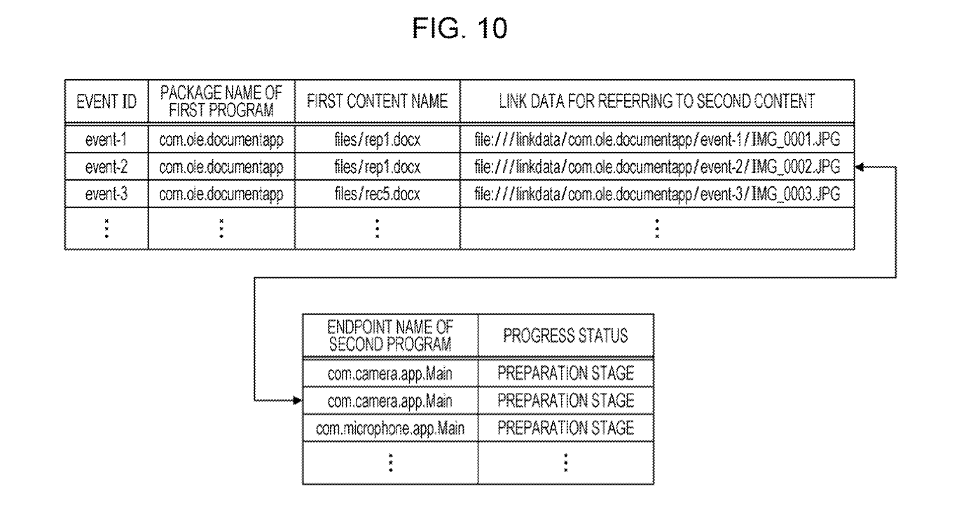

The application activating unit 411 activates an application. The content managing unit 413 manages contents. The event determining unit 415 determines triggering of an event. The event-table storing unit 417 stores an event table. The event table is explained below with reference to FIG. 8. The cooperation managing unit 419 manages cooperation among the applications. The cooperation-table storing unit 421 stores a cooperation table. The cooperation table is explained below with reference to FIG. 10. The instructing unit 423 instructs the document creation application 401 to integrate a photographic image. Note that the platform layer is equivalent to an operating system and middleware.

Note that, in order to support a case where the first content is other than a document, another application for generating the first content may be provided instead of the document creation application 401. In the following explanation, an application for generating the first content is referred to as a first program.

In order to support a case where the second content is other than a photographic image, another application for generating the second content may be provided. Note that, in the following explanation, an application for generating the second content is referred to as a second program.

The application activating unit 411, the content managing unit 413, the event determining unit 415, the cooperation managing unit 419, and the instructing unit 423 are implemented using hardware resources (for example, FIG. 3) and a computer program for causing a processor to execute processing explained below.

The policy-table storing unit 409, the event-table storing unit 417, and the cooperation-table storing unit 421 are implemented using hardware resources (for example, FIG. 3).

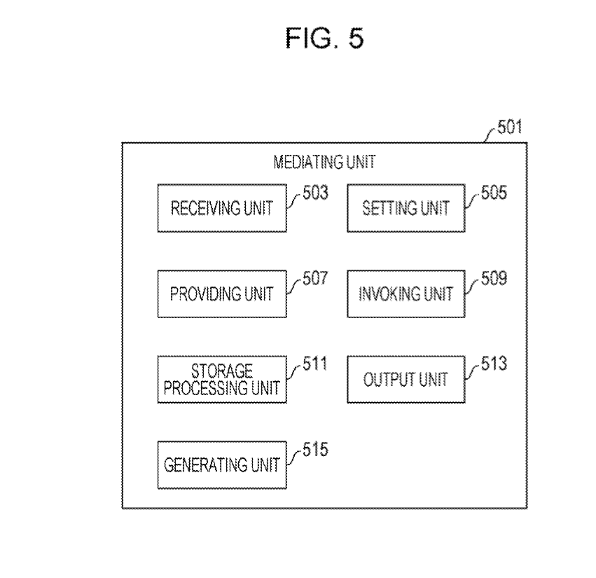

A module configuration example of a mediating unit 501 is illustrated in FIG. 5. The mediating unit 501 is implemented by causing the processor to execute the mediation application 405. The mediating unit 501 includes a receiving unit 503, a setting unit 505, a providing unit 507, an invoking unit 509, a storage processing unit 511, an output unit 513, and a generating unit 515.

The mediating unit 501 mediates cooperation among the applications. The receiving unit 503 receives, for example, a trigger condition of an event and selection of the second program associated with the event. The setting unit 505 sets the trigger condition of the event. The providing unit 507 provides link data to the first program. The invoking unit 509 invokes various computer programs. The storage processing unit 511 stores the second content in a storage location indicated by link data. The output unit 513 outputs a message. The generating unit 515 generates an event condition based on a context.

The mediating unit 501, the receiving unit 503, the setting unit 505, the providing unit 507, the invoking unit 509, the storage processing unit 511, the output unit 513, and the generating unit 515 are implemented using hardware resources (for example, FIG. 3) and a computer program for causing the processor to execute processing explained below.

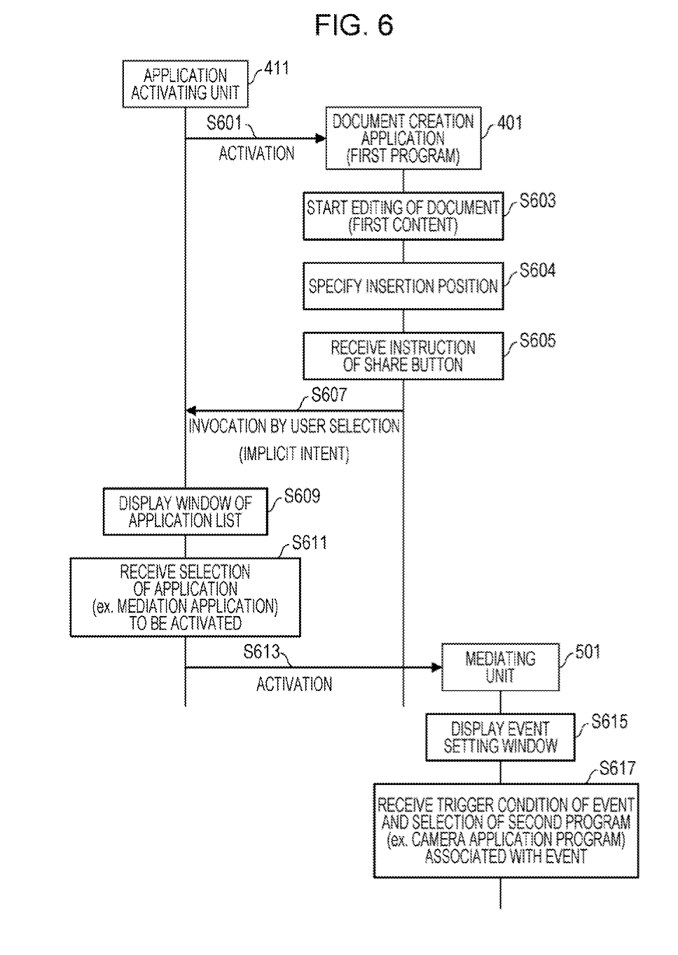

An operational sequence is explained. An operational sequence in the preparation phase is illustrated in FIG. 6. For example, when an icon of the document creation application 401 is touched in an initial menu, the application activating unit 411 activates the document creation application 401 (S601).

The document creation application 401 starts editing of a document (S603). An insertion position is specified during the editing (S604). For example, a cursor position is equivalent to the insertion position. When the user touches, during the editing of the document, the share button displayed on the screen 101, the document creation application 401 receives an instruction of the shared button (S605). Then, the document creation application 401 performs invocation of an application by user selection via the application activating unit 411 (S607). At this point, an invocation command passed from the document creation application 401 to the application activating unit 411 is sometimes referred to as implicit intent.

When being requested to perform the invocation by the document creation application 401, the application activating unit 411 displays a window of an application list indicating candidates to be invoked by the document creation application 401 (S609). It is assumed that the user selects the mediation application 405. That is, the application activating unit 411 receives selection of the mediation application 405 as an application to be activated (S611). The application activating unit 411 activates the mediation application 405 (S613).

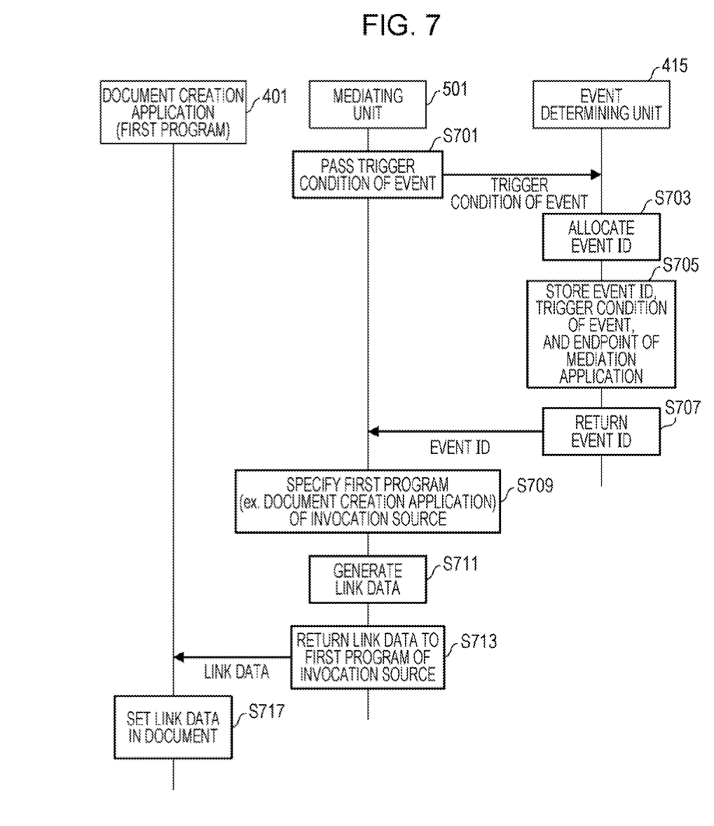

When the mediation application 405 is executed, the operation of the mediating unit 501 is started. The receiving unit 503 of the mediating unit 501 displays an event setting window (S615). The receiving unit 503 of the mediating unit 501 receives a trigger condition of an event and selection of the second program associated with the event (S617). It is assumed that the camera application 403 is selected. The sequence continues to an operational sequence illustrated in FIG. 7.

The setting unit 505 of the mediating unit 501 passes the received trigger condition of the event to the event determining unit 415 (S701).

When receiving the trigger condition of the event, the event determining unit 415 allocates an event ID to the trigger condition of the event (S703). The event determining unit 415 stores the event ID, the trigger condition of the event, and an endpoint of the mediation application 405 (S705). Specifically, the event determining unit 415 creates a new record in the event table and stores the event ID, the trigger condition of the event, and the endpoint of the mediation application 405 in the record.

The event table is explained. An example of the event table is illustrated in FIG. 8. The event table in this example includes a record corresponding to the event (hereinafter referred to as event record). The event record includes a field in which the event ID is stored, a field in which the trigger condition of the event is stored, and a field in which an endpoint of a notification destination is stored.

The event ID identifies the event. The trigger condition of the event is used to determine triggering of the event. The trigger condition of the event includes a field in which a type of the event is set and a field in which a parameter is set.

The type of the event is, for example, a geofence, a BLE beacon, and a timer. When the type of the event is the geofence, for example, a range of a geographical location is set as the parameter. When the type of the event is the BLE beacon, for example, an ID of a BLE transmitter is set as the parameter. When the type of the event is the timer, for example, a date and time is set as the parameter.

The endpoint of the notification destination specifies a notification destination at the time when the event is triggered.

Referring back to FIG. 7, when the event record is added, the event determining unit 415 returns the event ID of the event record to the mediating unit 501 (S707).

When receiving the event ID, the mediating unit 501 shifts to processing for providing link data to the document creation application 401.

The providing unit 507 of the mediating unit 501 specifies a computer program that has invoked the mediation application 405 (S709). The specified computer program is the first program (in this example, the document creation application 401). The providing unit 507 of the mediating unit 501 generates link data corresponding to the trigger condition of the event (S711). The providing unit 507 of the mediating unit 501 returns the link data to the first program of the invocation source (S713).

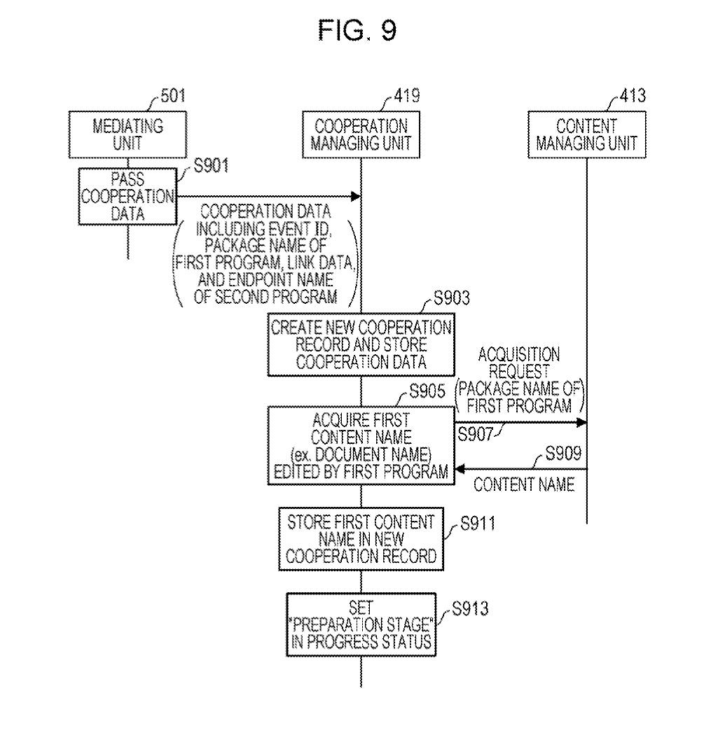

When receiving the link data, the document creation application 401 sets the link data in an insertion position in the document being edited (S717). The sequence continues to an operational sequence illustrated in FIG. 9.

Subsequently, the mediating unit 501 passes cooperation data to the cooperation managing unit 419 (S901). The cooperation data includes the event ID, a package name of the first program, the link data, and an endpoint name of the second program.

When receiving the cooperation data, the cooperation managing unit 419 creates a new record in the cooperation table and stores the cooperation data in the record (S903).

The cooperation table is explained. An example of the cooperation table is illustrated in FIG. 10. The cooperation table in this example includes a record concerning cooperation among the applications (hereinafter referred to as cooperation record). The cooperation record includes a field in which the event ID is stored, a field in which the package name of the first program is stored, a field in which a first content name is stored, a field in which link data (which may link a file or a directory) for referring to the second content is stored, a field in which the endpoint name of the second program is stored, and a field in which a progress status is set.

The event ID specifies an event serving as timing for activating the second program. The package name of the first program is an example of identification information of the first program. The first program may be specified by identification information other than the package name. The first content name identifies a first content that refers to the second content. The endpoint name of the second program is an example of identification information of the second program. The second program may be specified by identification information other than the package name. The progress status in this example is any one of a “preparation stage”, a “link stage”, and an “integration stage”. The “preparation stage” indicates that the preparation phase is ended. The “link stage” indicates that the link phase is ended. The “integration stage” indicates that the second content has been integrated into the first content.

Referring back to FIG. 9, the cooperation managing unit 419 acquires, from the content managing unit 413, relying on the passed link data, a name (in this example, a document name including a storage path) of the first content edited by the first program (in this example, the document creation application 401) (S905).

At this point, the content managing unit 413 passes, in response to an acquisition request (including the package name of the first program) passed from the cooperation managing unit 419 (S907), the name of the first content edited by the first program to the cooperation managing unit 419 (S909).

The cooperation managing unit 419 stores the first content name in a new cooperation record (S911). Further, the cooperation managing unit 419 sets the “preparation stage” in a field of a progress status in the new cooperation record (S913). The operational sequence in the preparation phase is as explained above.

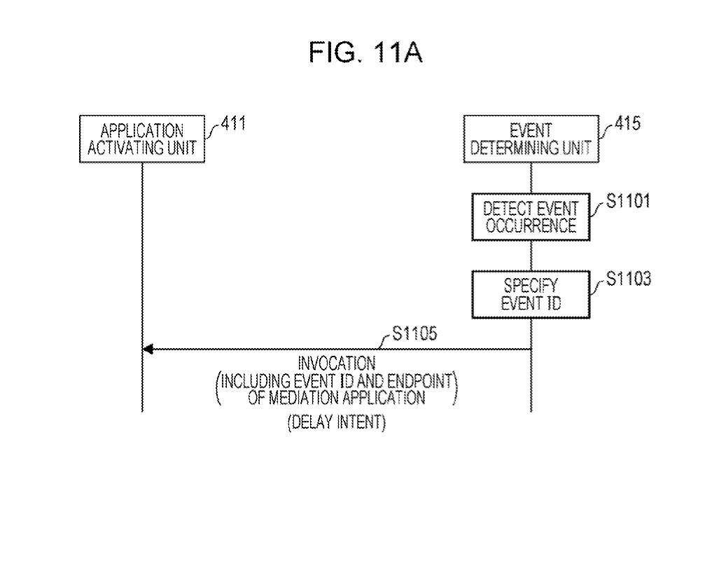

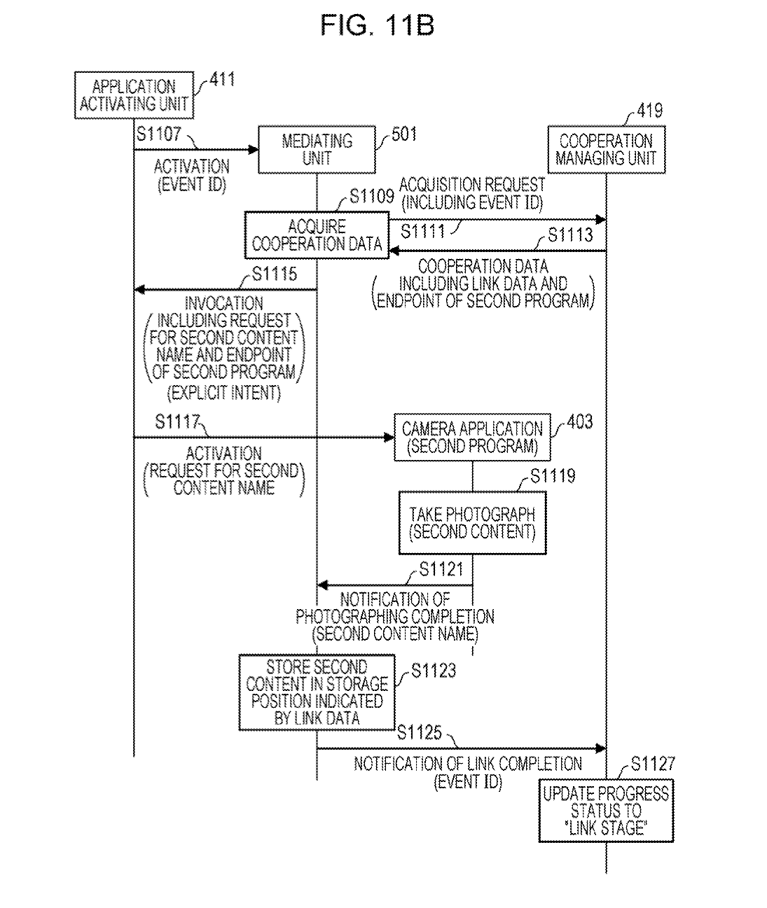

An operational sequence in the link phase is explained. The operational sequence in the link phase is illustrated in FIGS. 11A and 11B. When the event determining unit 415 detects an event trigger, based on the trigger condition of the event (S1101), the event determining unit 415 specifies an event ID associated with the trigger condition (S1103). The event determining unit 415 invokes the mediation application 405, which is a notification destination of the event ID, via the application activating unit 411 (S1105). At this point, an invocation command passed from the event determining unit 415 to the application activating unit 411 includes the event ID and an endpoint of the notification destination (in this example, the endpoint of the mediation application 405). The invocation command passed after waiting for the event trigger in this way is sometimes referred to as delay intent. The sequence continues to an operational sequence illustrated in FIG. 11B.

When being requested to invoke the mediation application 405 by the event determining unit 415, the application activating unit 411 activates the mediation application 405 while being accompanied by the event ID (S1107).

When the mediation application 405 is activated, the operation of the mediating unit 501 starts. The mediating unit 501 receives the event ID. The mediating unit 501 acquires cooperation data associated with the event ID from the cooperation managing unit 419 (S1109).

At this point, the cooperation managing unit 419 returns, in response to an acquisition request including the event ID (S1111), the cooperation data corresponding to the event ID to the mediation application 405 (S1113). The cooperation data returned to the mediation application 405 includes the link data and the endpoint name of the second program.

The invoking unit 509 of the mediating unit 501 invokes the second program (in this example, the camera application 403) via the application activating unit 411 (S1115). At this point, an invocation command passed from the invoking unit 509 of the mediating unit 501 to the application activating unit 411 includes a request for a second content name and an endpoint of the second program. The command for designating and invoking a computer program is sometimes referred to as explicit intent.

When being requested to invoke the second program by the invoking unit 509 of the mediating unit 501, the application activating unit 411 activates the camera application 403 while being accompanied by the request for the second content name (S1117).

The camera application 403 starts operation and receives the request for the second content name. The camera application 403 takes a photograph according to user operation (S1119). It is assumed that the name of the second content is determined by the camera application 403 and the second content is stored in a predetermined folder. The camera application 403 returns notification of photographing completion including the second content name to the mediating unit 501 (S1121).

The storage processing unit 511 of the mediating unit 501 specifies, with the second content name, the second content stored in the predetermined folder and stores the second content into a storage location indicated by the link data (S1123). At this point, the storage processing unit 511 of the mediating unit 501 causes a stored file name to coincide with a file name in the link data. The storage processing unit 511 of the mediating unit 501 may delete the second content present in the predetermined folder. The mediating unit 501 passes notification of link completion including the event ID to the cooperation managing unit 419 (S1125).

When receiving the notification of the link completion, the cooperation managing unit 419 updates a progress status in a cooperation record corresponding to the event ID included in the notification to the “link stage” (S1127).

According to this embodiment, content is automatically referred to by link data set beforehand. Therefore, link operation of the content is easy.

The second program for generating the second content may be activated at scheduled timing.

### Second Embodiment

In a second embodiment, an example is explained in which a message is output when the second program is invoked.

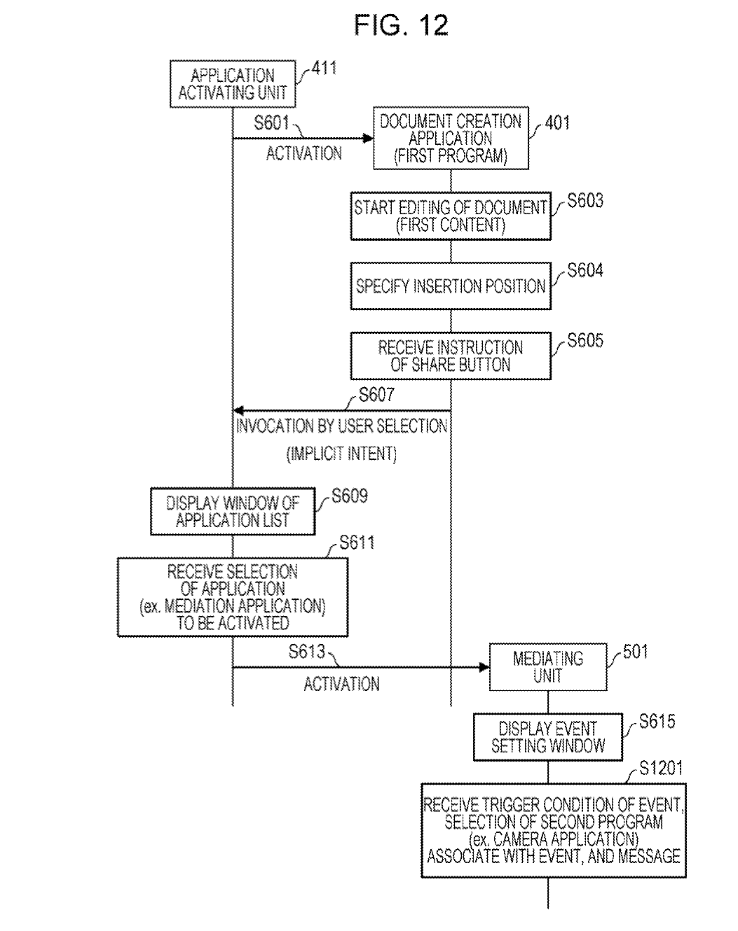

In FIG. 12, a sequence in a preparation phase according to the second embodiment is illustrated. Processing in S601 to S605 is the same as the processing illustrated in FIG. 6. The mediating unit 501 receives a message in addition to the trigger condition of the event and the selection of the second program associated with the event (S1201). That is, an event setting window is configured to receive the message as well.

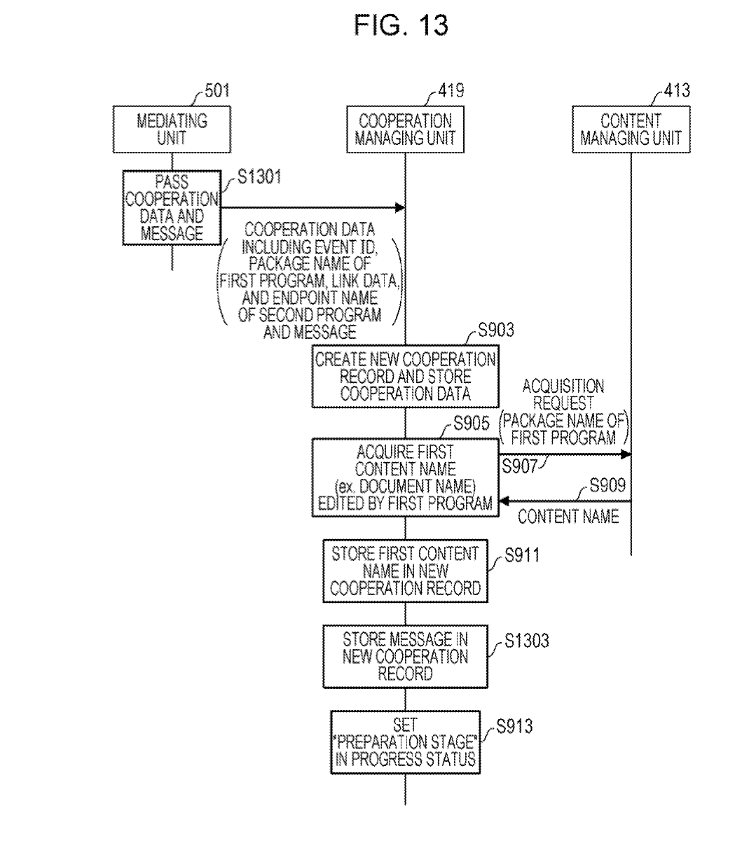

After the processing in S1201 illustrated in FIG. 12, the sequence shifts to the operational sequence illustrated in FIG. 7. Further, the sequence shifts to an operational sequence illustrated in FIG. 13. The mediating unit 501 passes the message to the cooperation managing unit 419 in addition to the cooperation data (S1301). Processing in S903 to S911 is the same as the processing illustrated in FIG. 9. The cooperation managing unit 419 stores the message in the new cooperation record (S1303).

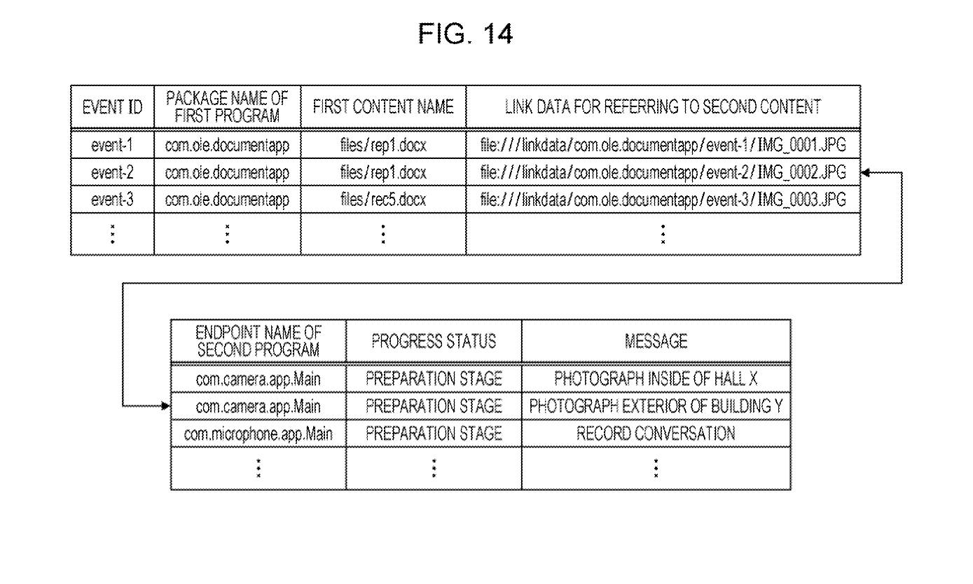

An example of the cooperation table in the second embodiment is illustrated in FIG. 14. The cooperation record in the second embodiment includes a field in which a message is stored. The message is words to be output when an event is triggered.

Referring back to FIG. 13, processing in S913 is the same as the processing illustrated in FIG. 9.

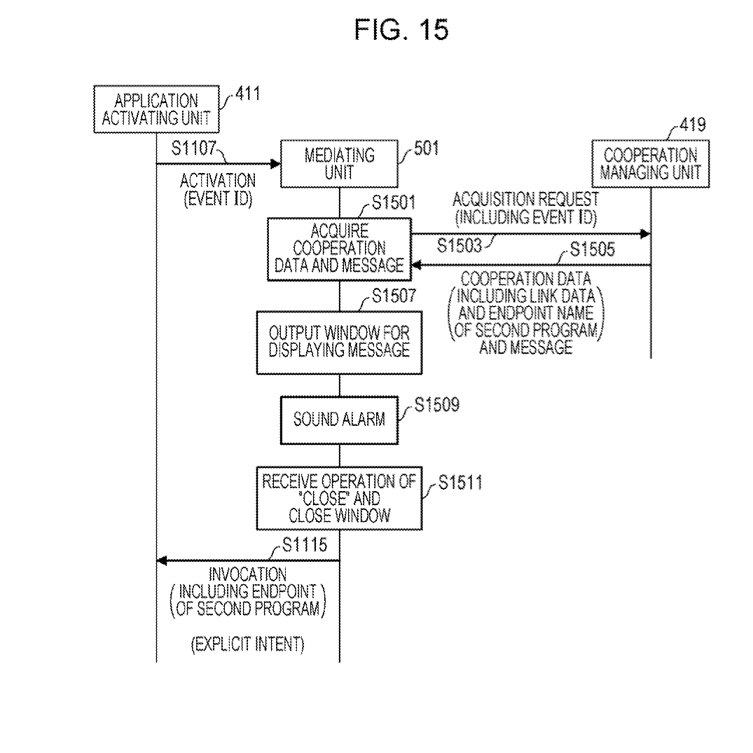

An operational sequence in the link phase is explained. The sequence shifts to a sequence illustrated in FIG. 15 after the operational sequence illustrated in FIG. 11A. Processing in S1107 is the same as the processing illustrated in FIG. 11B.

The mediating unit 501 acquires the message in addition to the cooperation data (S1501). At this point, the cooperation managing unit 419 returns, in response to an acquisition request including the event ID (S1503), cooperation data and a message corresponding to the event ID (S1505).

The output unit 513 of the mediating unit 501 outputs a window for displaying the message (S1507). The output unit 513 of the mediating unit 501 may sound an alarm (S1509). The output unit 513 of the mediating unit 501 receives operation for “close” by the user and closes the window (S1511). Processing after S1511 is the same as the processing in the first embodiment. Note that the output unit 513 of the mediating unit 501 may output the message by sound. The output unit 513 of the mediating unit 501 may output the message after the second program is activated.

According to this embodiment, it is possible to check the message concerning the second content at timing when the second content is generated.

### Third Embodiment

In a third embodiment, an example is explained in which the second content is integrated into the first content according to a policy.

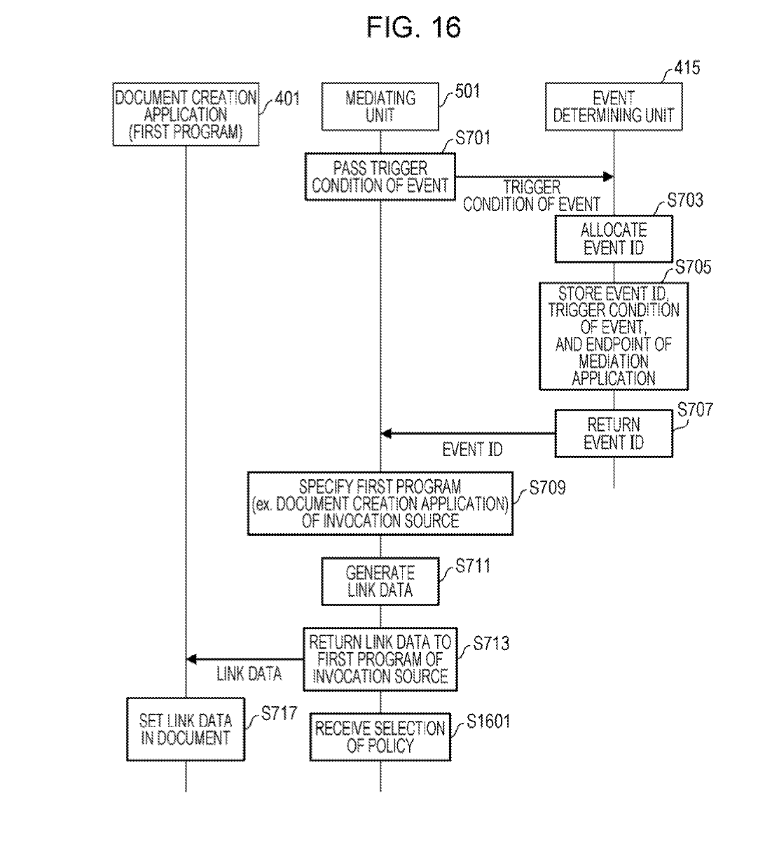

An operational sequence in a preparation phase according to the third embodiment is explained. The sequence shifts to an operational sequence illustrated in FIG. 16 following the operational sequence illustrated in FIG. 6. Processing in S701 to S717 is the same as the processing illustrated in FIG. 7. The receiving unit 503 of the mediating unit 501 receives selection of a policy (S1601). The policy relates to a method of integrating content.

An example of a policy table is illustrated in FIG. 17. The policy table in this example includes a record for a policy (hereinafter referred to as policy record). The policy record includes a field in which a policy ID is stored, a field in which content is stored, and a field in which an integration event ID is stored.

The policy ID identifies a policy. The content indicates an aim of the policy. The integration event ID specifies an integration event. The integration event ID is set when the event ID is “policy-3”.

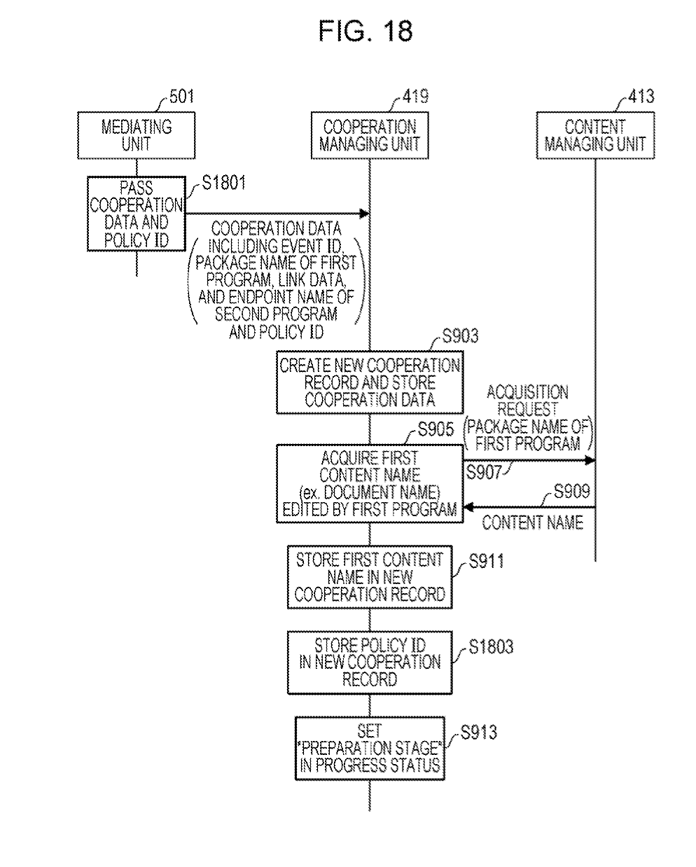

The operational sequence illustrated in FIG. 16 continues to the operational sequence illustrated in FIG. 18. The mediating unit 501 passes the policy ID to the cooperation managing unit 419 in addition to the cooperation data (S1801). Processing in S903 to S911 is the same as the processing illustrated in FIG. 9. After the processing in S911, the cooperation managing unit 419 stores the policy ID in the new cooperation record (S1803). Processing in S913 is the same as the processing illustrated in FIG. 9.

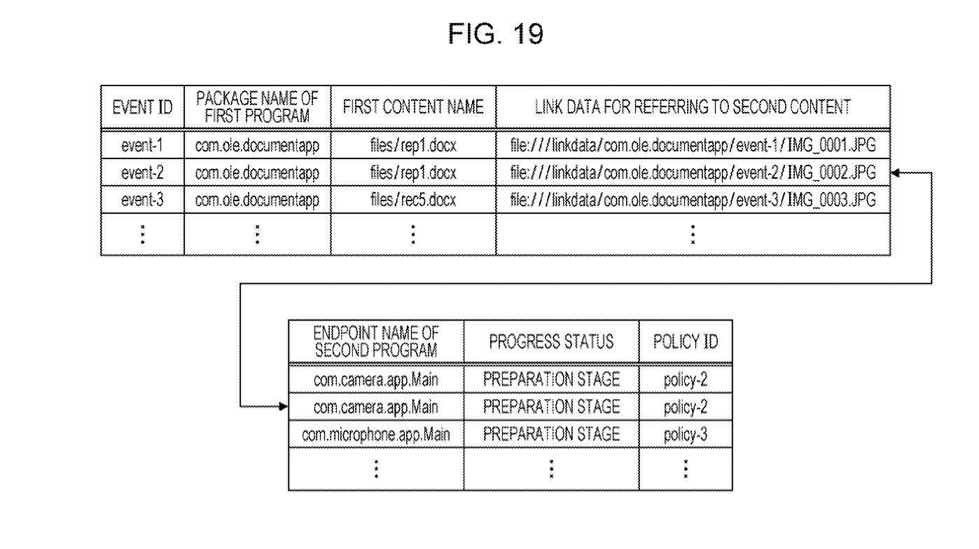

An example of a cooperation table in the third embodiment is illustrated in FIG. 19. The cooperation table in the third embodiment includes a field in which the policy ID is stored. The policy ID identifies the policy.

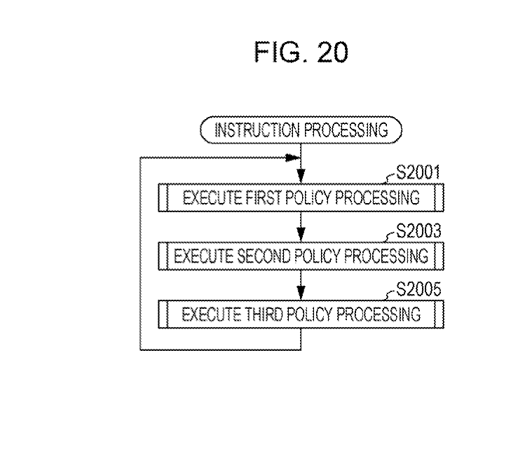

Operation for integrating the second content into the first content according to the policy is explained. An instruction processing flow is illustrated in FIG. 20. The instructing unit 423 executes first policy processing (S2001). In the first policy processing, the instructing unit 423 performs instruction based on a first policy having an ID “policy-1”.

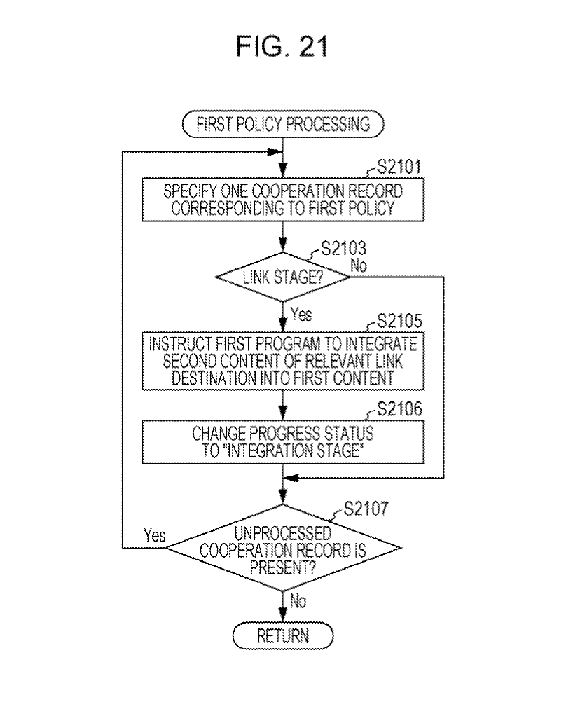

A first policy processing flow is illustrated in FIG. 21. The instructing unit 423 specifies one cooperation record corresponding to the first policy (S2101). The instructing unit 423 determines whether a progress status in the cooperation record is the “link stage” (S2103).

When determining that the progress status is the “link stage”, the instructing unit 423 instructs the first program to integrate the second content into the first content (S2105). For example, the instructing unit 423 allows the second content referred to by the link data stored in the cooperation record to be integrated. The instructing unit 423 updates the progress status in the cooperation record to the “integration stage” (S2106).

On the other hand, when determining that the progress status is not the “link stage”, the instructing unit 423 directly shifts to processing in S2107.

The instructing unit 423 determines whether there is an unprocessed cooperation record among cooperation records corresponding to the first policy (S2107). When determining that there is an unprocessed cooperation record, the instructing unit 423 returns to the processing in S2101 and repeats the processing explained above. On the other hand, when determining that there is no unprocessed cooperation data, the instructing unit 423 ends the first policy processing and returns to the instruction processing for an invocation source.

Referring back to FIG. 20, subsequently, the instructing unit 423 executes second policy processing (S2003). In the second policy processing, the instructing unit 423 performs instruction based on a second policy having an ID “policy-2”.

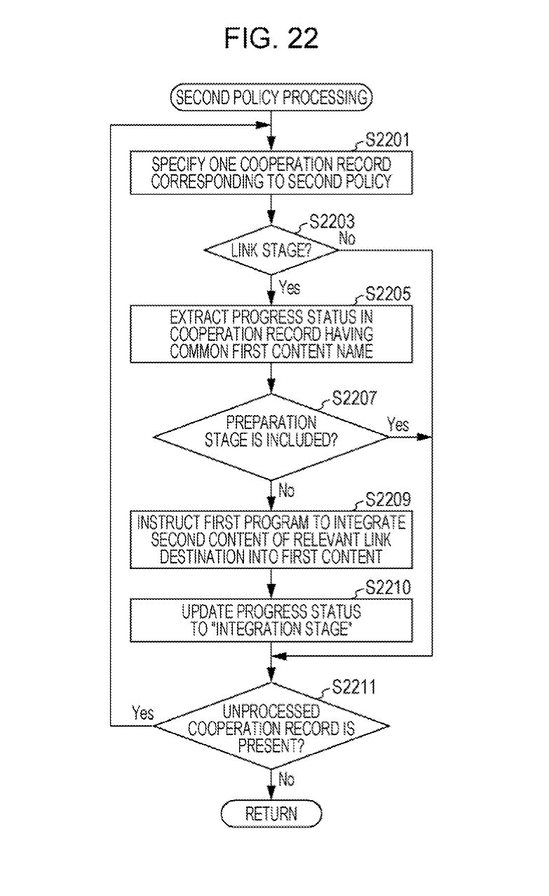

A second policy processing flow is illustrated in FIG. 22. The instructing unit 423 specifies one cooperation record corresponding to the second policy (S2201). The instructing unit 423 determines whether a progress status in the cooperation record is the “link stage” (S2203).

When determining that the progress status in the cooperation record is the “link stage”, the instructing unit 423 extracts progress statuses in cooperation records having a common first content name (S2205). The instructing unit 423 determines whether the “preparation stage” is included in the extracted progress statuses (S2207).

When determining that the “preparation stage” is not included in the extracted progress statuses, as explained above, the instructing unit 423 instructs the first program to integrate the second content into the first content (S2209). The instructing unit 423 updates the progress status in the cooperation record to the “integration stage” (S2210).

On the other hand, when determining that the “preparation stage” is included in the extracted progress statuses, the instructing unit 423 directly shifts to processing in S2211. When determining that the progress status is not the “link stage”, the instructing unit 423 also directly shifts to the processing in S2211.

The instructing unit 423 determines whether there is an unprocessed cooperation record among cooperation records corresponding to the second policy (S2211). When determining that there is an unprocessed cooperation record, the instructing unit 423 returns to the processing in S2201 and repeats the processing explained above. On the other hand, when determining that there is no unprocessed cooperation record, the instructing unit 423 ends the second policy processing and returns to the instruction processing for an invocation source.

Referring back to FIG. 20, subsequently, the instructing unit 423 executes third policy processing (S2005). In the third policy processing, the instructing unit 423 performs instruction, based on a third policy having an ID “policy-3”.

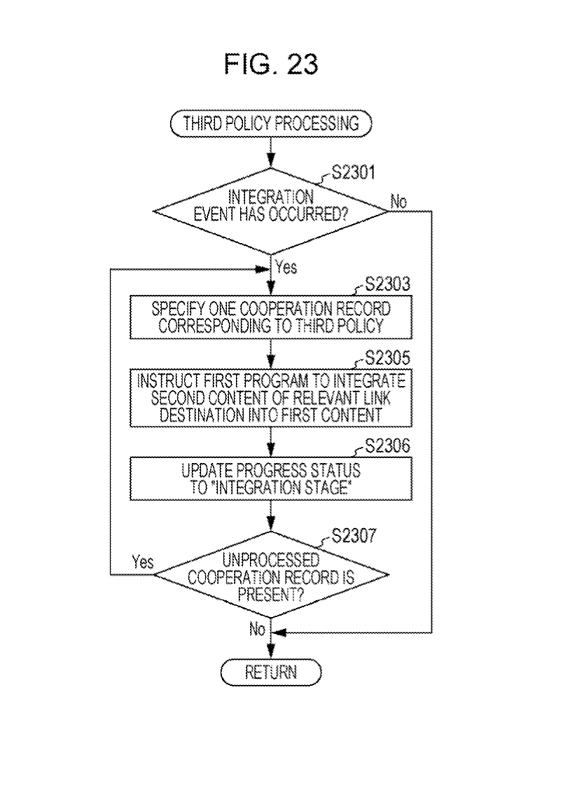

A third policy processing flow is illustrated in FIG. 23. The instructing unit 423 determines whether an integration event has occurred (S2301). For example, when receiving notification of an integration event ID from the event determining unit 415, the instructing unit 423 determines that an integration event has occurred.

When determining that the integration event has not occurred, the instructing unit 423 directly ends the third policy processing. Then, the instructing unit 423 returns to the instruction processing for an invocation source.

On the other hand, when determining that the integration event has occurred, the instructing unit 423 specifies one cooperation record corresponding to the third policy (S2303). As explained above, the instructing unit 423 instructs the first program to integrate the second content into the first content (S2305). The instructing unit 423 updates the progress status in the cooperation record to the integration stage (S2306).

The instructing unit 423 determines whether there is an unprocessed cooperation record among cooperation records corresponding to the third policy (S2307). When determining that there is the unprocessed cooperation record, the instructing unit 423 returns to the processing in S2303 and repeats the processing explained above. On the other hand, when determining that there is no unprocessed cooperation record, the instructing unit 423 ends the third policy processing. When ending the third policy processing, the instructing unit 423 returns to the instruction processing for an invocation source.

Referring back to FIG. 20, when ending the third policy processing, the instructing unit 423 returns to S2001 and repeats the processing explained above.

According to this embodiment, work for integrating the second content is reduced.

It is possible to automate the integration of the second content according to a schedule for finishing the first content.

### Fourth Embodiment

In a fourth embodiment, an example is explained in which an event condition is generated based on a context set in the scheduler 407.

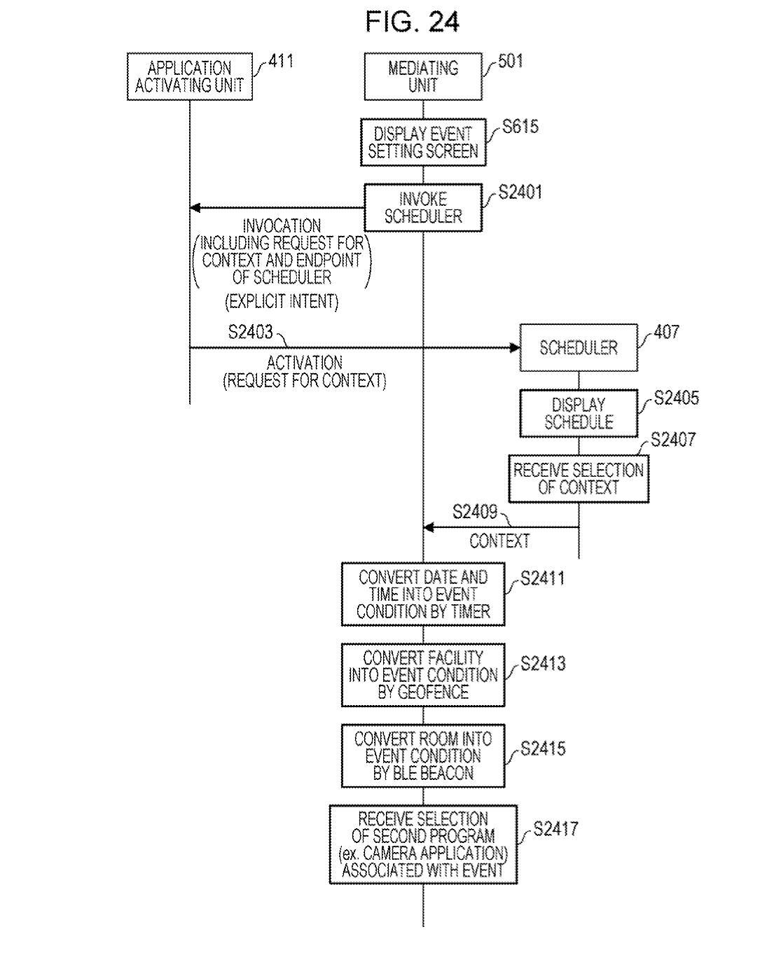

In a preparation phase according to the fourth embodiment, as in the embodiments explained above, the sequence in S601 to S613 in FIG. 6 advances. The sequence shifts to an operational sequence illustrated in FIG. 24. Processing in S615 is the same as the processing illustrated in FIG. 6.

The generating unit 515 of the mediating unit 501 invokes the scheduler 407 according to, for example, an instruction of the user (S2401). At this point, an invocation command passed from the generating unit 515 of the mediating unit 501 to the application activating unit 411 includes a request for a context and an endpoint of the scheduler 407.

When being requested to perform the invocation by the generating unit 515 of the mediating unit 501, the application activating unit 411 activates the camera application 403 while being accompanied by the request for the context (S2403).

The activated scheduler 407 displays a schedule (S2405). The scheduler 407 receives selection of a context by user operation (S2407). The scheduler 407 returns the selected context to the mediating unit 501 (S3409). It is assumed that the context includes data such as a date and time, a facility, or a room.

When data of a date and time is included in the received context, the generating unit 515 of the mediating unit 501 converts the date and time into an event condition by a timer (S2411). Specifically, a type of an event is a “timer”. A parameter is the date and time.

When data of a facility is included in the received context, the generating unit 515 of the mediating unit 501 converts the facility into an event condition by a geofence based on a geographical location of the facility (S2413). Specifically, a type of an event is a “geofence”. A parameter is a range including a geographical location of the facility.

When data of a room is included in the received context, the generating unit 515 of the mediating unit 501 converts the room into an event condition by a BLE beacon set in the room (S2415). Specifically, a type of an event is a “BLE beacon”. A parameter is an ID of a BLE transmitter set in the room.

The receiving unit 503 of the mediating unit 501 receives selection of the second program associated with the event (S2417). The sequence continues to the operational sequence illustrated in FIG. 7.

According to this embodiment, setting of the event condition for activating the computer program for generating the second content is simplified.

Note that, instead of the BLE beacon, an event based on a beacon by another wireless communication scheme (for example, a wireless LAN) may be generated. An event by another type may be used. A plurality of event conditions may be combined.

The embodiments of the present disclosure are explained above. However, the present disclosure is not limited to the embodiments. For example, the functional block configuration sometimes does not coincide with a program module configuration.

The configurations of the storage regions explained above are examples. Configuration of the storage regions do not have to be the configurations explained above. Further, in the processing flow, if a processing result does not change, the order of processing may be changed or a plurality of kinds of processing may be executed in parallel.

The embodiments explained above are summarized as described below.

An information processing apparatus according to an aspect includes: (A) a providing unit configured to provide a first program to generate a first content with link data to be set in the first content so as to refer to a second content; (B) an invoking unit configured to invoke a second program when a first condition associated with the provided link data is satisfied; and (C) a storage processing unit configured to store the second content generated by the invoked second program into a storage location indicated by the provided link data.

Consequently, since the second content may be referred to according to the link data set in advance, link operation of the second content is simplified.

Further, the first condition may be a condition concerning at least any one of a geographical location, a received radio signal, and a time.

Consequently, it is possible to activate a computer program for generating the second content at scheduled timing.

The information processing apparatus may further include an output unit configured to output a message when the second program is invoked.

Consequently, it is possible to check a message concerning the second content at timing when the second content is generated.

The information processing apparatus may further include an instructing unit configured to instruct the first program to integrate the stored second content into the first content.

Consequently, work for integrating the second content is reduced.

The instructing unit may perform the instruction when a second condition concerning at least any one of a geographical location, a received radio signal, and a time is satisfied.

Consequently, it is possible to automate the integration of the second content according to a schedule for finishing the first content.

The information processing apparatus may further include a generating unit configured to generate the first condition based on a context set in a scheduler.

Consequently, setting of a condition for activating the computer program for generating the second content is simplified.

Note that it is possible to create a computer program for causing a processor to perform the processing in the information processing apparatus. The computer program may be stored in a computer-readable storage medium or storage device such as a flexible disk, a CD-ROM, a magneto-optical disk, a semiconductor memory, or a hard disk. Note that, in general, an intermediate processing result is temporarily saved in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and configured to:
provide a first program to generate a first content with link data to be set in the first content so as to refer to a second content,
invoke a second program when a first condition associated with the provided link data is satisfied, and
store the second content generated by the invoked second program into a storage location indicated by the provided link data.

2. The apparatus of claim 1, wherein
the first condition is a condition concerning at least one of a geographical location, a received radio signal, and a time.

3. The apparatus of claim 1, wherein
the processor is further configured to output a message when the second program is invoked.

4. The apparatus of claim 1, wherein
the processor is further configured to provide the first program with an instruction to integrate the stored second content into the first content.

5. The apparatus of claim 4, wherein
the processor provides the instruction when a second condition concerning at least one of a geographical location, a received radio signal, and a time is satisfied.

6. The apparatus of claim 1, wherein
the processor is further configured to generate the first condition, based on a context set in a scheduler.

7. A method comprising:
providing a first program to generate a first content with link data to be set in the first content so as to refer to a second content;
invoking a second program when a first condition associated with the provided link data is satisfied; and
storing the second content generated by the invoked second program into a storage location indicated by the provided link data.

8. A non-transitory, computer-readable recording medium having stored therein a program for causing a computer to execute a process comprising:
providing a first program to generate a first content with link data to be set in the first content so as to refer to a second content;
invoking a second program when a first condition associated with the provided link data is satisfied; and
storing the second content generated by the invoked second program into a storage location indicated by the provided link data.
